(19) United States
(12) Patent Application Publication
(10) Pub. No.: US 2026/0346245 A1
(43) Pub. Date: Nov. 5, 2026

(54) DEVICE FOR ANALYSIS OF A LIQUID

(71) Applicant: Magia Diagnostics, Echirolles (FR)

(72) Inventor: Roman Gorbenkov, Echirolles (FR)

(21) Appl. No.: 19/099,344

(22) PCT Filed: Jul. 18, 2023
(86) PCT No.: PCT/EP2023/069942

§ 371 Date: Jan. 28, 2025

(30) Foreign Application Priority Data
Jul. 28, 2022 (FR) FR2207782

(51) Int. Cl. B01L 3/00

(52) U.S. Cl. CPC B01L 3/502715; B01L 2200/025; B01L 2200/028; B01L 2300/0663; B01L 2300/0864; B01L 2300/0887; B01L 2400/043; B01L 2400/0439; B01L 2400/0478

(57) ABSTRACT

An analysis device for biological analysis to detect the presence and/or concentration of a species in a liquid contained in an analysis chamber of a cartridge comprises piezoelectric vibration means equipped with a disengageable piezoelectric finger.

### CROSS-REFERENCE TO RELATED APPLICATIONS

This application is a national phase entry under 35 U.S.C. § 371 of International Patent Application PCT/EP2023/069942, filed Jul. 18, 2023, designating the United States of America and published as International Patent Publication WO 2024/022900 A1 on Feb. 1, 2024, which claims the benefit under Article 8 of the Patent Cooperation Treaty of French Patent Application Serial No. FR2207782, filed Jul. 28, 2022.

### TECHNICAL FIELD

The technical field of the present disclosure is that of biological analysis to detect the presence and/or concentration of a species (analyte) in a liquid, especially a biological liquid. The present disclosure relates more particularly to an analysis device configured to engage with an analysis cartridge provided with a chamber in which there is a liquid to be analyzed.

### BACKGROUND

Document EP3447492 discloses a method for capturing and detecting a species, often referred to as an “analyte,” in a liquid, especially a biological liquid. The principles for capturing and detecting patterns implemented by this method are also explained in the article by Fratzl et al, “Magnetophoretic induced convective capture of highly diffusive superparamagnetic nanoparticles,” Soft Matter, 14. 10.1039/C7SM02324C.

This method notably comprises a step that consists of mixing a sample, made up of a liquid to be analyzed, with magnetic particles. These particles, in these regards, have a nanometric or more generally sub-micrometric size, and are coupled to capture elements capable of binding specifically to the species to be detected and/or quantified. This species, the analyte, may be an antigen and the element an antibody, but the reverse configuration is also possible.

Detection elements are also introduced into the sample during this step. The detection elements may notably comprise a detection antibody or antigen carrying a photoluminescent, for example, fluorescent, marker.

At the end of this step, complexes formed of the capture element, the species and the detection element are thus formed in the solution. These complexes are then immobilized on a support comprising magnetic micro-sources ordered in a specific spatial pattern. The pattern is defined by strong magnetic field zones and weak magnetic field zones inducing significant magnetic field gradients. The complexes entrained by the magnetic particles tend to agglomerate on the support at the zones where the norm of the magnetic field is maximum. The photoluminescent (and especially fluorescent) markers can make the specified spatial pattern apparent, which marks the presence of the analyte in the solution. The mean (spatially) intensity of this light pattern is usually referred to as “specific signal.”

In most cases, and particularly when the analyte is absent from the sample or when its quantity is limited in the sample, the unbound detection elements carrying the photoluminescent markers remain dispersed in suspension in the solution. They contribute to forming a relatively homogeneous light background. The mean (spatially) intensity of this light background forms a signal called “signal of the supernatant.” Besides the unbound photoluminescent markers, this light background is also formed by the light intensity emitted by all the photoluminescent materials of the sample. The capture elements not bound to the analyte and to the detection element are also immobilized on the support, but do not carry markers; they do not contribute to the light pattern or to the light background.

The spatial arrangement in the plane of the support of the magnetic field microsources and the light intensity of the patterns exposed by the photoluminescent markers make it possible to carry out a detection and a quantification of the analyte in the sample without washing, that is to say without eliminating the liquid solution after having immobilized the complexes on the surface of the support, which is particularly advantageous. To enable this detection, the sample and the surface of the support are illuminated in order to allow the detection of the photoluminescent markers and the acquisition of a digital image is carried out. This digital image therefore has a spatially variable intensity (in the plane of the image) depending on the intensity of the magnetic field produced by the support. The image is processed to identify this spatial variation, and to determine the specific signal and the signal of the supernatant, and the specific signal/signal of the supernatant ratio makes it possible to conclude that the analyte is present in the sample or even to estimate the concentration thereof.

The simplicity of this approach, and, in particular, the absence of washing step, allows its integration into an autonomous, portable or transportable immunological analysis device “at the patient's bedside,” in the field and without a pump or valve, whereas traditionally this type of analysis is conducted in a central laboratory.

To allow the application of the detection method, the biological liquid is introduced into a cartridge, for example, a single-use cartridge, comprising a plurality of analysis chambers, this cartridge being intended to be inserted into the analysis device. The plurality of analysis chambers makes it possible to conduct several analyses from a sample of biological liquid, each analysis being able to be independently carried out on samples respectively held in each of the chambers.

The cartridge comprises a pour opening for the liquid, a plurality of vents arranged downstream of the analysis chambers and a network of channels for fluidly connecting the opening to the analysis chambers. The sample of biological liquid poured into the opening propagates by capillary action in the network of channels to fill the chambers.

Although this cartridge undeniably offers a number of advantages, it requires a great deal of handling, which should be reduced.

In addition, this implementation also requires the magnetic particles and/or detection elements to be effectively dissolved and mixed.

One aim of the present disclosure is to propose an analysis device for implementing effective mixing of magnetic particles and/or detection elements present in an analysis chamber of an analysis cartridge.

### BRIEF SUMMARY

The aim of the present disclosure is achieved by an analysis device for biological analysis to detect the presence and/or concentration of a species in a liquid that comprises:
a support for receiving at least one analysis cartridge so that the analysis cartridge rests on the support by one of its faces, and which comprises an essentially planar rear face, and coincident with an XY plane, the analysis cartridge comprising at least one chamber capable of containing a liquid intended to be analyzed;
piezoelectric vibration means equipped with a piezoelectric finger, the piezoelectric finger extends between two ends referred to, respectively, as a first end and a second end, the piezoelectric vibration means being arranged so that the piezoelectric finger can adopt one or other of two positions referred to, respectively, as the engaged position and the disengaged position, the engaged position being a position in which the second end bears against the support or the rear face when the analysis cartridge rests on the support, while the disengaged position is a position in which the second end is at a distance from the support and from the rear face so as to allow the analysis cartridge to be removed;
engagement means configured to allow the piezoelectric finger to move between one of the engaged position and the disengaged position to the other of these two positions, the engagement means involving a translational movement or a pivotal movement.

According to one embodiment, the piezoelectric finger is configured to impose a vibration on the rear face as soon as the second end rests against the rear face.

According to one embodiment, the piezoelectric finger is configured to exert, against the rear face, a bearing force perpendicular to the XY plane when in its engaged position.

According to one embodiment, the analysis device comprises complementary magnetic means intended to impose a complementary magnetic field in the at least one chamber of the analysis cartridge.

According to one embodiment, the analysis device further comprises means for analyzing the liquid capable of being present in the at least one chamber.

According to one embodiment, the analysis means comprise a detector and a radiation source configured to analyze a liquid capable of being present in the analysis chamber.

According to one embodiment, the support is perforated so as to make the rear face of the analysis cartridge accessible through the second end when the cartridge rests with the rear face thereof on the support.

According to one embodiment, the device comprises loading means engaging with the support and configured to impose on the support one or the other of an analysis position and a loading position, the loading position being a position allowing the positioning and/or removal of the analysis cartridge from the support, while the analysis position is a position allowing the engagement of the piezoelectric finger against the rear face of the analysis cartridge, advantageously the loading means comprise a worm gear.

According to one embodiment, the analysis position is also a position allowing the analysis of the fluid contained in the chamber by the analysis means.

According to one embodiment, the piezoelectric finger is mounted on a lever.

According to one embodiment, the piezoelectric vibration means comprise a hollow cylindrical body, which, together with the piezoelectric finger, forms a piston, a so-called piezoelectric piston, the piezoelectric finger being partially housed, coaxially with the hollow cylindrical body, in the hollow cylindrical body and partly opening out through an opening in the hollow cylindrical body, the piezoelectric vibration means further comprise a guide cylinder wherein the hollow cylindrical body is partially housed in sliding connection.

According to one embodiment, the engagement means comprise a cam linked to a shaft, and acting on the hollow cylindrical body to impose a translational movement thereon along the direction of elongation of the piezoelectric finger, the shaft is advantageously rotationally controlled by means of a motor, in particular, a stepper motor.

According to one embodiment, the piezoelectric vibration means comprise a suspension mechanism configured so that the piezoelectric finger, when in its engaged position, imposes a predetermined contact force on the rear face.

According to one embodiment, the suspension mechanism comprises a spring mounted in compression and bearing on the one hand against the hollow cylindrical body and on the other hand against a shoulder of the piezoelectric foot.

According to one embodiment, the shaft is mounted so that it can rotate about an axis perpendicular to the direction of elongation of the piezoelectric finger.

According to one embodiment, the support comprises wedges configured to force the rear face of the analysis cartridge to be coincident with the XY plane.

According to one embodiment, the analysis device comprises additional means for holding the analysis cartridge on the support, these additional holding means are notably configured to hold the analysis cartridge at the vents of the cartridge and communicating with the chamber, the additional holding means are also configured to obturate the vents.

### BRIEF DESCRIPTION OF THE DRAWINGS

Other features and advantages will become apparent in the following description of an analysis cartridge and an analysis device according to the present disclosure, given by way of non-limiting examples, with reference to the appended drawings wherein:

FIG. 1 is a schematic perspective depiction of an analysis cartridge capable of being implemented according to of the principles of the present disclosure;

FIG. 2 is a schematic depiction of the fluidic section according to a cross-sectional plane of the fluidic section parallel to the upper face, FIG. 2 represents, in particular, the at least one analysis chamber in fluidic communication on the one hand with the opening via the channels and on the other hand with the at least one vent via the at least one vent channel;

FIG. 3 is a schematic depiction of the cartridge shown in FIG. 1 in perspective and in exploded view;

FIG. 4A is a schematic depiction along a cross-sectional plane (perpendicular to the main faces) of the cartridge of FIG. 1 at the at least one analysis chamber;

FIG. 4B is another schematic depiction along a cross-sectional plane (perpendicular to the main faces) of the cartridge of FIG. 1 at the at least one analysis chamber, the cartridge implementing a non-magnetic layer;

FIG. 4C is a perspective depiction of an interlayer film capable of being used to assemble the cartridge shown in FIG. 1;

FIG. 4D is a schematic depiction, in top view, of a detection pattern defined by the magnetization produced by a magnetic layer integrated into the support of a cartridge, the magnetic field present in an analysis chamber and the norm of this field;

FIG. 5 is a schematic depiction of a liquid-filled analysis chamber that comprises, suspended for analysis, magnetic nanoparticles grafted with capture agents and detection agents, and FIG. 5 notably shows the formation mechanism for the complexes;

FIG. 6 is a depiction of an analysis device implemented according to the principles of the present disclosure;

FIGS. 7A and 7B are depictions of the interior of the analysis device of FIG. 6, the finger of the piezoelectric vibration means being in a disengagement position, FIG. 7B being a cross-sectional view;

FIG. 7C is a depiction of the interior of the analysis device of FIG. 6, the finger of the piezoelectric vibration means being in an engaged position;

FIG. 8 exemplifies, according to a perspective view, a support capable of being used within the scope of the present disclosure. In particular, the support shown in this figure can accommodate two analysis cartridges;

FIG. 9 is an illustration of the support shown in FIG. 8 and accommodating an analysis cartridge on one of its sites;

FIG. 10 is an illustration of a piezoelectric finger capable of being implemented within the scope of the present disclosure;

FIG. 11 is a depiction, along a cross-sectional plane along the axis of elongation of the piezoelectric finger, of piezoelectric vibration means according to an advantageous embodiment of the present disclosure;

FIG. 12 is a depiction, according to a perspective view, of a hollow cylindrical body used in the piezoelectric vibration means of FIG. 11;

FIG. 13 is a depiction, according to a perspective view, of a guide cylinder used in the piezoelectric vibration means of FIG. 11.

### DETAILED DESCRIPTION

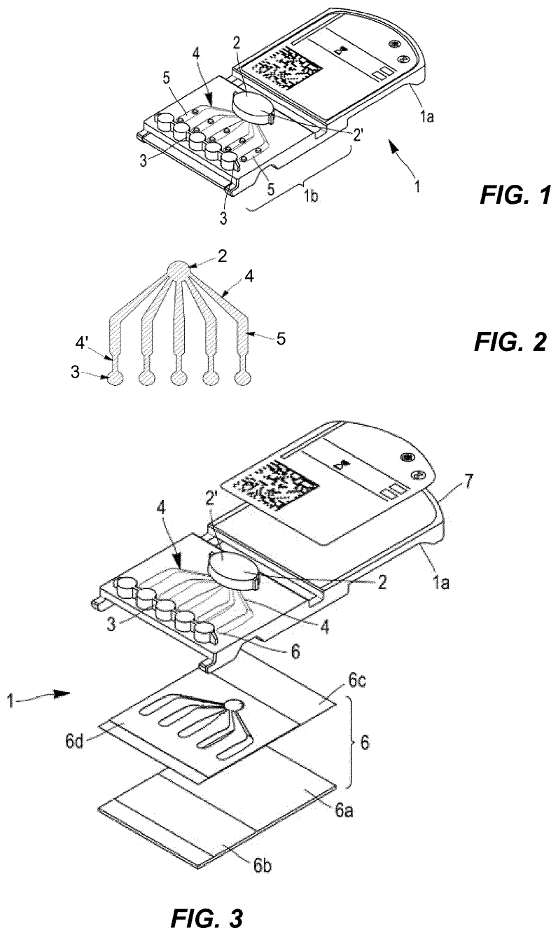

FIG. 1 shows an analysis cartridge 1 for the analysis of a species (hereinafter “analyte”) capable of being present in a liquid, and more particularly a biological liquid.

The analysis cartridge 1 is, in these regards, adapted to receive a sample of a liquid, for example, a biological liquid, in order to detect the presence of a given analyte in the liquid.

The analysis cartridge 1 thus comprises at least one micro-fluidic analysis chamber 5. In particular, the analysis cartridge may comprise between 1 and 10, for example, 5 analysis chambers 5. It is understood that an analysis chamber may itself comprise a plurality of housings arranged in series. However, the remainder of the present disclosure will be limited to the description of a chamber having a single housing and referred to by the word “chamber.”

The analysis cartridge 1 may comprise a gripping end 1a for the handling thereof. The gripping end la may bear a label, for example, provided with a bar code or a two-dimensional code, allowing identification and traceability of the analyses carried out by means of the analysis cartridge 1 in question. The identification means may alternatively comprise an “RFID” chip.

The analysis cartridge 1 also comprises an active section 1b formed, for example, in the extension of the gripping end 1a.

The active section 1b is generally planar in shape and comprises two main faces known, respectively, as the upper face and lower face.

The analysis cartridge 1 may comprise at least one pour opening 2, which allows a liquid to be introduced into the analysis cartridge 1. This opening 2 notably opens onto the upper face of the active section 1b.

In particular, the opening 2 is in fluidic communication with at least one analysis chamber 5. Notably, the active section comprises at least one micro-fluidic channel 4 providing fluidic communication between the opening 2 and the at least one analysis chamber 5. In other words, the at least one micro-fluidic channel 4 ensures the flow and distribution of the liquid poured into the opening 2 toward the at least one analysis chamber.

The analysis cartridge 1 may also comprise at least one vent 3 in fluidic communication with the at least one analysis chamber 5 (FIGS. 1 and 2). The at least one vent 3 is notably configured to allow the evacuation of air capable of being present in the at least one analysis chamber 5 when the latter is filled with liquid. In particular, the fluidic communication between the at least one analysis chamber 5 and the at least one vent 3 is ensured by at least one vent channel 4′.

Thus, in operation, a liquid sample is introduced, for example, by means of a pipette, into the opening 2. The sample then flows into the at least one analysis chamber 5 via the at least one micro-fluidic channel 4. Air that may be present in the at least one analysis chamber 5 is expelled during the flow of the liquid in the analysis chamber 5 toward the at least one vent 3.

In the case of a plurality of analysis chambers 5, the micro-fluidic channels 4 may be arranged so that the flow of the liquid sample is either simultaneous in each of the chambers 5 or sequential. “Sequential flow” is understood to mean that the analysis chambers 5 are filled according to a predetermined order. In particular, according to this principle, the flow in a given chamber only begins when the analysis chamber preceding it in the filling order is completely full.

Still in the case of a plurality of analysis chambers 5, it can also be envisaged that the analysis cartridge comprises a plurality of openings, for example, one opening dedicated to each chamber of the cartridge.

The analysis cartridge 1 shown in FIG. 1 may further comprise a reservoir 2′ surmounting the opening 2, the volume of which equals that of the micro-fluidic network formed by the at least one micro-fluidic channel 4, the at least one analysis chamber 5 and the at least one vent channel 4′. In this respect, this volume may be between 5 mm³ and 500 mm³, and more specifically between 20 mm³ and 100 mm³.

Similarly, the at least one vent 3 is surmounted by a peripheral wall in order to retain an excess volume of liquid, according to the principle of communicating vessels. Advantageously, the peripheral wall has a height at least equal to the height of the reservoir 2′ in order to prevent the liquid escaping from the analysis cartridge 1. This arrangement reduces the risk of health problems or even damage to an analysis device (described hereinafter) into which the analysis cartridge 1 is intended to be inserted.

By way of illustration, the analysis cartridge 1 may have a dimension of between 2 cm and 10 cm in width and in length, and have a thickness of between 4 mm and 10 mm. The at least one analysis chamber 5 may have a volume typically between 1 mm³ and 50 mm³ to receive the sample, advantageously between 5 mm³ and 25 mm³.

According to a non-limiting example shown in FIG. 3, the analysis cartridge 1 may be formed of a support 6 and an upper cover 7 covering the support 6. The support 6 and the upper cover 7 are notably assembled together by placing their so-called “main” surfaces facing one another.

The at least one analysis chamber 5, the at least one micro-fluidic channel 4 and the at least one vent channel 4′ form a micro-fluidic network of the analysis cartridge 1. This micro-fluidic network is notably defined by recesses formed on the main surface of the support 6 and/or on the main surface of the upper cover 7, that is to say on one and/or the other of the faces of these two elements, which are intended to be assembled together.

Each channel 4, 4′ is delimited, on the one hand, by the main surfaces of the support 6 and of the cover 7 forming, respectively, a bottom and a ceiling, and on the other hand, by side walls connecting the bottom and the ceiling. The distance separating the bottom and the ceiling of a channel 4, 4′ defines a channel height, while the distance separating two opposing side walls defines a channel width. The ceiling, the bottom and the side walls typically form walls of the chamber.

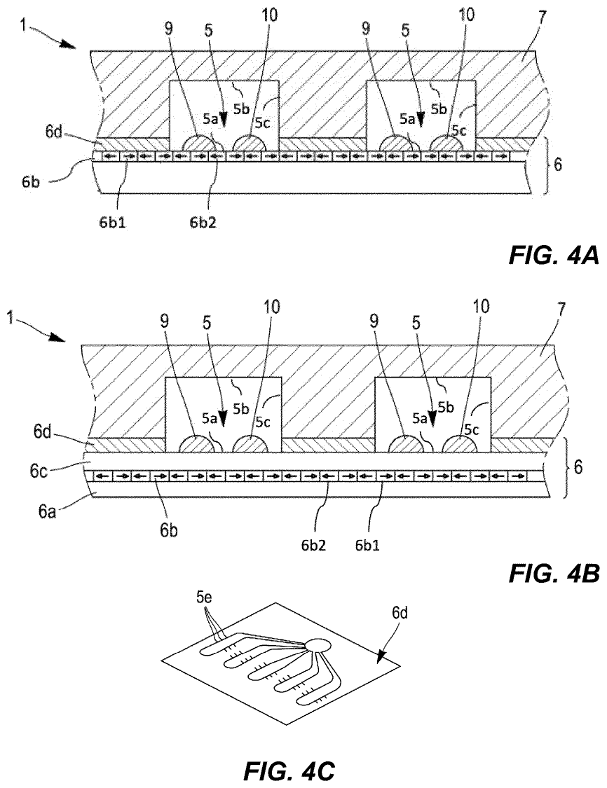

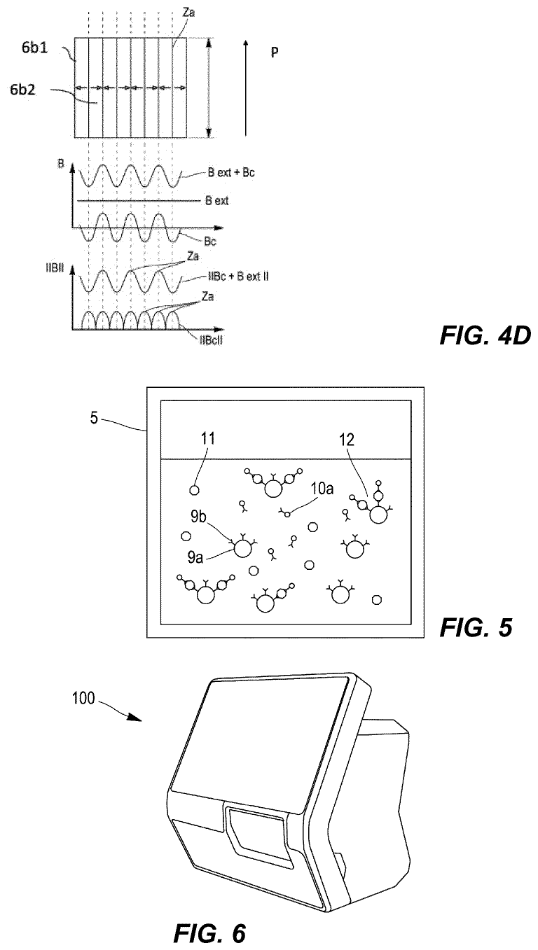

Equivalently, the at least one analysis chamber 5 is also delimited by the main surfaces of the support 6 and of the cover 7 forming, respectively, a chamber bottom 5a and a chamber ceiling 5b (FIGS. 4A and 4B). The at least one chamber 5 further comprises chamber side walls 5c that extend from the chamber bottom 5a toward the chamber ceiling 5b. It is understood, however, that at least one analysis chamber 5 may be devoid of a ceiling, and for example, form an open well at the active section.

It is also understood that the side walls of the at least one chamber may be deformable.

The upper cover 7, at least for the part that overhangs the at least one analysis chamber 5, may be made of a material that is transparent to a photoluminescence signal capable of being emitted by the detection agents described hereinafter. The material forming the upper cover 7 may comprise at least one of the materials selected from: a plastic material based, for example, on polycarbonate, cyclic olefin copolymer or polystyrene, or glass.

The outer surface of the cover 7 may be optically polished at least in line with the at least one analysis chamber 5.

The micro-fluidic network, such as the one presented in FIG. 2, therefore extends in the main plane of the analysis cartridge 1. It is millimetric in size, that is to say that the width of the channels 4, 4′ and the analysis chambers 5 is typically between 0.1 mm and 10 mm. The height of these elements, that is to say the distance separating the bottom from a ceiling, is also between 0.1 mm and 10 mm. The liquid capable of being introduced at the opening 2 spreads through the micro-fluidic network by capillary action.

The analysis cartridge 1 according to the present disclosure may also comprise at least one first cluster 9 adhering to the bottom of the at least one analysis chamber 5 (FIG. 4A). The at least one first cluster 9 is notably formed of magnetic nanoparticles 9a held together and onto which capture agents 9b are grafted (FIG. 5).

Alternatively, it may be possible to arrange the at least one first cluster on the ceiling 5b of the at least one chamber 5. This configuration can notably facilitate the resuspension (described below) of the first cluster when the latter is subjected to magnetic forces due to the presence of a magnetic layer 6b described hereinafter.

A first cluster may advantageously have a volume of between 0.1 μL and 5 μL and advantageously between 0.5 μL and 2 μL.

“Held together” is understood to mean a set of nanoparticles bonded together. This cohesion between nanoparticles can be direct or indirect. Direct cohesion may, in particular, be provided by dry or freeze-dried nanoparticles, while indirect cohesion can be ensured by an encapsulation material. In this respect, the encapsulation material may comprise sugar (trehalose, glucose, etc.) or viscous solution (for example, TWEEN®), or glycerol.

The retention of the nanoparticles between them, and in the form of clusters, ensures better stability thereof over time.

The implementation of an encapsulation material makes it possible to facilitate the suspension of nanoparticles presented below in the rest of the description.

The magnetic nanoparticles 9a can be nanometric in size, typically between 25 nm and 500 nm, and preferentially between 100 nm and 300 nm. The magnetic nanoparticles 9a can be generally spherical in shape. They feature superparamagnetic characteristics and are biocompatible. They may also be covered with a polymer (of polystyrene type) having a surface treatment that allows them to be functionalized, for example, with type Ac or Ag proteins. The controlled quantity of the particles is such that their concentration in the volume of the chamber once filled with liquid to be analyzed is comprised between 10⁶ particles/mL and 10¹² particles/mL, advantageously between 10⁹ particles/mL and 10¹¹ particles/mL.

The capture agents 9b are able to bind specifically to the analyte capable of being present in the liquid. In this respect, the analyte can be an antigen, while the capture agent 9b comprises an antibody (the reverse configuration is also possible).

The analysis cartridge 1 may also comprise at least one second cluster 10 adhering to the bottom of the at least one analysis chamber 5 (FIGS. 4A and 4B). The at least one second cluster 10 is notably formed of detection agents 10a bound therebetween (FIG. 5).

It is understood, without it needing to be specified, that the first cluster 9 and the second cluster 10 can form a single cluster. In addition, the first cluster 9 and the second cluster 10 can both be deposited on a chamber wall.

Advantageously, the first cluster 9 and/or the second cluster 10 is based on a surface energy density associated with a hydrophobic surface. The surface energy density can be determined, as is well known per se, by measuring the contact angle of a water drop, arranged on the surface whose energy is to be measured. A high contact angle, greater than 90°, indicates a low surface energy density, and the surface is said to be hydrophobic. Conversely, a contact angle of less than 90° indicates a high surface energy density, and is a so-called hydrophilic surface. Consideration of a hydrophobic surface makes it possible to impose a relatively spherical shape on one and/or other of the first cluster and the second cluster.

A second cluster can advantageously have a volume of between 0.1 μL and 5 μL and advantageously between 0.5 μL and 2 μL.

The at least one first cluster 9 and the at least one second cluster 10 are both intended, respectively, to allow capture, or even immobilization, of an analyte 11 present in a liquid, and to detect, or even quantify, the presence of the analyte 11. To this end, the analyte 11 present in a liquid, and in the presence of detection agents 10a and magnetic nanoparticles 9a on which capture agents 9b are grafted, forms complexes 12 with these elements (FIG. 5).

Magnetic nanoparticles are intended to isolate complexes, while detection agents are used to detect them.

Thus, using the analysis cartridge 1 to detect and/or quantify an analyte in a liquid involves pouring a sample of the liquid into the at least one analysis chamber via the opening 2.

The formation of complexes 12 also involves suspending the elements forming the first cluster 9 and the second cluster 10 in the liquid sample present in the analysis chamber 5.

This suspension may, in particular, comprise a separation of the first and the second clusters from the bottom 5a of the chamber 5 as well as a separation of the elements from one another in order to disperse them in the sample. To this end, the piezoelectric vibration means 110 described hereinafter may be used.

These piezoelectric vibration means 110 are notably adapted to impose a vibration on the chamber bottom 5a. This vibration generates an acoustic pressure field in the liquid present in the analysis chamber 5, and thus suspends the elements forming the first cluster 9 and the second cluster 10.

According to a first variant, the vibration can be imposed at fixed frequencies, for example, between 5 kHz and 2 MHz, advantageously between 20 kHz and 200 kHz. Still according to this first variant, the vibration can be close to a resonant frequency of the analysis chamber 5 (“close to the resonant frequency” is understood to mean a frequency within +/−15%, advantageously within +/−10%, even more advantageously within +/−5% of the resonant frequency of the analysis chamber). Advantageously, the resonant frequency of analysis chamber 5 is of the order of 50 kHz, or of the order of 80 kHz or of the order of 110 kHz.

An analysis chamber having such resonant frequencies may comprise, along a cross-sectional plane perpendicular to the rear face of the cartridge, a rectangular section terminating at each of these two ends in a mouth whose cross-section, along the same plane, is triangular. The length and width of the rectangular section are 8.4 mm and 2.4 mm, respectively, while the base and the height of the triangular section are 2.4 mm and 4 mm, respectively. The height of the analysis chamber is 390 μm.

According to a second variant, the vibration can be imposed in the form of cycles, and, for example, in the form of repeated cycles. In these regards, a cycle may comprise a sweep in increasing or decreasing frequency, and more particularly a sweep in frequency around the resonant frequency of the analysis chamber. The complete frequency sweep can last between 10 seconds and 200 seconds. In particular, this frequency sweep comprises a stepwise incrementation or decrementation of the frequency.

In particular, each step corresponds to maintaining the frequency for a period of time, which may be between 2 seconds and 10 seconds so as to allow the liquid to move sufficiently for a minimal mixing effect.

By way of example, a cycle may involve a frequency sweep from 110 kHz to 120 kHz, or conversely a frequency sweep from 120 kHz to 110 kHz. This sweep can be carried out in steps of 1 kHz, with the vibration held for a few seconds and, in particular, for 2 seconds, at each step.

Again by way of example, the vibratory sequence may comprise the repetition of an elementary sequence that comprises a first cycle and a second cycle.

The first cycle may comprise a frequency sweep from 120 kHz to 111 kHz in 1 kHz steps with the vibration held at each step for 2 seconds.

The second cycle may comprise a frequency sweep from 110 kHz to 119 kHz in steps of 1 kHz with the vibration held at each step for 2 seconds.

This elementary sequence can, for example, be repeated from 1 to 4 times.

It is also possible to consider a vibration at a fixed frequency (for example, approximately equal to one of the frequencies selected from: 56 kHz, 74 kHz, 80 kHz, 110 kHz) continuously or in the form of one or more pulses. The fixed frequency is advantageously equal to, or at least close to, a natural frequency of the analysis chamber (natural frequency means the assembly formed by the resonant frequency and its harmonics).

Particularly advantageously, the side walls 5c may be structured to create vortices favorable to mixing in the sample as the sample circulates in the analysis chamber. This structuring of the side walls 5c may comprise a crenelated surface.

Particularly advantageously, gas, and more particularly air, is initially trapped in the side wall 5c of the at least one chamber 5.

The trapped gas can be released under the action of mechanical stress applied to the at least one analysis chamber and thus generate gas bubbles on the side wall of the at least one chamber as soon as the liquid sample is present in the at least one chamber 5. This mechanical stress may, in particular, be applied to the rear face of the analysis cartridge 1.

According to one embodiment, the side walls 5c of the at least one chamber 5 can be made of a porous material. The gas is initially located in the pores of the porous material.

According to an alternative or complementary embodiment, the gas may be initially trapped in slots 5e opening onto the side walls (FIG. 4C).

The slots 5e can have a length of between 100 μm and 1000 μm, and a cross-section whose largest dimension is between 100 μm and 400 μm.

The cross-section of a slot may comprise at least one of the shapes selected from: square, rectangle, round.

According to the present disclosure, as soon as the gas bubbles are generated (notably under the effect of the previously described stress), the acoustic pressure field, generated by vibration of the chamber bottom, allows these latter to vibrate in the liquid present in the analysis chamber.

These vibrating gas bubbles then act as additional vibrating agents that improve the mixing of the liquid present in the analysis chamber.

This effect may however be optimized by forcing the gas bubbles to vibrate at a frequency close to their resonant frequency (“close to the resonant frequency” is understood to mean a frequency within +/−15%, advantageously within +/−10%, even more advantageously within +/−5% of the resonant frequency of the gas bubbles). Indeed, under these conditions, the contribution of gas bubbles to the mixture is exacerbated, especially as some bubbles are capable of transmitting energy through their implosion and the resulting shock wave.

To this end, the pores and/or slots trapping the gas may be configured so that the gas bubbles capable of being generated have a resonant frequency close to that of the analysis chamber.

In particular, for the slot sizes specified, the bubble sizes can range from 50 μm to 500 μm. For this range of bubble sizes, the resonant frequencies are between 20 kHz and 500 kHz.

Still according to the present disclosure, the analysis cartridge 1 may comprise a magnetic layer 6b (FIG. 4A) arranged to immobilize the magnetic nanoparticles 9a of the at least one analysis chamber 5 on the bottom of the chamber. It is therefore understood that this magnetic layer also serves to immobilize the complexes 12. The magnetic layer 6b is advantageously microstructured so that the magnetic nanoparticles immobilized on the bottom of the analysis chamber 5 form a predefined pattern.

In these regards, the magnetic layer 6b may comprise a repeated juxtaposition of at least a first region 6b1 and a second region 6b2. More particularly, the first region 6b1 may have a magnetic polarization along a first direction, and the second region 6b2 may have either zero magnetic polarization or a magnetic polarization along a second different direction, preferentially 180°, from the first direction (FIG. 4A).

The support 6 can notably be arranged so that it comprises, from its main face to the rear face, an interlayer film 6d, the magnetic layer 6b and a rigid substrate 6a. It is understood that the magnetic layer 6b does not necessarily extend over the entire surface of the substrate 6a (FIGS. 3, 4A, and 4B).

The rigid substrate 6a may comprise a plastic material. The magnetic layer 6b may be arranged on the substrate 6a, or integrated into this substrate, at least at the analysis chambers 5 of the microfluidic network.

The magnetic layer 6b may comprise magnetic composite materials, such as ferrites, randomly distributed in a polymer or oriented along a pre-orientation axis. This magnetic layer 6b may be similar to a conventional magnetic recording tape. In this latter case, the micro-structuring of a magnetic layer is associated with magnetic coding (notably via a magnetic recording/playback head). More particularly, micro-structuring in this latter case means creating magnetic zones that may differ in magnetization from one zone to another in terms of orientation and/or amplitude. For example, two adjacent zones can have two opposite orientations, and more particularly 180°.

The substrate 6a may also comprise a non-magnetic layer 6c (or a plurality of such films) sandwiched between the magnetic layer 6b, and the interlayer film 6d. This non-magnetic layer 6c, which is optional, is designed to keep the magnetic layer 6b away from the bottom of the analysis chamber 5.

The term “non-magnetic layer” refers to a layer with a magnetic susceptibility of zero or less (in absolute terms) than 10⁻³.

The non-magnetic layer 6c may, for example, comprise a plastic material, such as a polypropylene on an acrylic.

In the example shown above, the interlayer film 6d defines the micro-fluidic network. In particular, the interlayer film 6d shown in FIG. 4C is cut according to a pattern corresponding to the micro-fluidic network. When this interlayer film 6d is assembled to the substrate 6a to form the support 6, the latter therefore has recesses reproducing the cutout pattern of the film 6d. These recesses, optionally in combination with complementary recesses formed in the upper cover 7, form the micro-fluidic network of the cartridge 1.

Particularly advantageously, the interlayer film 6d is an adhesive film, also allowing the upper cover 7 to be assembled and hermetically sealed to the support 6 at their surfaces in contact, that is, surrounding the recesses. It may, for example, be a double-sided adhesive film, thus simultaneously ensuring its assembly to the substrate 6a and to the upper cover 7. As is well known per se, such an interlayer film 6d may consist of a strip, for example, plastic, both faces of which are coated with an adhesive material.

Still advantageously, the gas or air bubbles, when mechanical stress is applied to the bottom of the chamber, may be generated by releasing gas trapped in the interlayer film. Thus, this film may be porous and/or comprise slots, for example, formed when the pattern corresponding to the micro-fluidic network is cut.

Returning to the description of the magnetic nature of the analysis cartridge, the magnetic layer 6b comprises a succession of regions 6b1 and 6b2 polarized in two different directions (opposite in FIGS. 4A and 4B). As shown in FIG. 4D, which shows, in top view, the magnetic layer 6b, the magnetically polarized regions extend in line along a main direction P in the example shown.

Regions of relatively high magnetic intensity, known as attraction zones, are observed at the interfaces between the zones of different polarization. The attraction zones are notably arranged in the form of a plurality of lines Za oriented along the main direction P. The particular arrangement of these lines defines, in combination, a detection pattern.

It is understood that the in-line arrangement taken in an example only forms a particular case of a detection pattern. An analysis cartridge 1 is more generally provided with magnetically polarized regions defining a well-determined detection pattern, but the configuration of which can be freely chosen.

The field Bc generated by the magnetic layer 6b and its norm are also shown in FIG. 4D. As will be explained hereinafter, it may be useful to add an additional (or complementary) external field Bext to the field produced by the layer 6b. FIG. 4D shows this external field Bext, which combines with the field Bc produced by the layer and the norm of this combined field. It is observed that the application of this external magnetic field Bext can lead to eliminating certain attraction zones Za produced when only the field provided by the magnetic layer 6b is present. However, in every case, these attraction zones are arranged along lines Za oriented in the main direction P, or more generally according to a detection pattern, the features of which are fully determined.

In the case of an analysis chamber 5 having the dimensions indicated previously, it is possible to consider forming a detection pattern comprising between 2 and 50 lines, the lines having a thickness of between 1 μm and 150 μm (advantageously between 5 μm and 30 μm) and separated from each other by a spacing of between 5 μm and 300 μm, advantageously between 25 μm and 150 μm.

Based on this description, the surface gradient was calculated at the surface of a non-magnetic layer with a thickness of around 55 μm and resting on a magnetic layer.

The micro-magnets in the magnetic layer, on which the non-magnetic layer rests, are 50 μm wide and 10 μm high. These micro-magnets feature plane polarization and alternate with one another. In this calculation, an NdFeB magnetic field source with a remanence of 1.2 T below this magnetic layer is also used. This imposes a magnetic field with an amplitude of between 0.005 Tesla and 0.3 Tesla.

As part of this calculation, it was demonstrated that the gradients on the surface of the non-magnetic layer are between 50 T/m and 150 T/m, and can be extended by plus or minus one order of magnitude. As a result of these gradients, a magnetic force is exerted on the particles. This force is capable of retaining the magnetic particles (especially the clusters), and also contributes to their immobilization (described at the end of the present disclosure).

Thus, when a liquid sample is introduced into the analysis cartridge 1, the sample flows through the micro-fluidic channels 4 to fill the at least one analysis chamber 5 and propagate through the vent channels 4′. A vibration and a mechanical stress are imposed on the rear face of the analysis cartridge 1. Gas bubbles are then generated by the release of gas under the effect of the mechanical stress. The acoustic pressure field resulting from the vibration imposed on the bottom suspends and, if necessary, mixes the elements forming the first cluster and the second cluster. This acoustic pressure field can, additionally, cause the gas bubbles to vibrate.

The vibration of these bubbles also contributes, to a certain extent, to the suspension and mixing of the detection agents 10a and capture agents 9b associated with the magnetic nanoparticles 9a in the liquid sample present in the analysis chamber 5. During the following reaction time, and when the analyte is present in the sample, complexes comprising at least one capture element, at least one magnetic nanoparticle, at least one analyte, and at least one detection element are formed. These complexes are immobilized on the support 6 of the analysis chamber 5 by agglomerating in a preferred manner at the maximum of the norm of the magnetic field intensity (induced by the micro-sources and optionally the external magnetic field), and therefore in order to be arranged according to the detection pattern defined by the magnetic layer 6b. The excess detection elements remain suspended in the sample.

Provision may be made for each analysis chamber 5 of a cartridge 1 to be prepared to receive capture elements and detection elements of different natures, so as to carry out multiple analyses of a liquid sample introduced into the analysis cartridge 1. Provision may also be made for the detection pattern encoded by the portion of the magnetic layer 6b that is arranged at a chamber 5 to be different from one chamber to the other.

It is also possible to consider a magnetic layer that comprises a zone devoid of magnetic zones, and directly above which the first cluster is formed (resuspension of magnetic nanoparticles from the first cluster can thus be facilitated).

In every case, the presence of an analyte in the sample retained in an analysis chamber 5 leads to the formation of a detection pattern defined by the magnetic layer 6b.

The present disclosure also relates to an analysis device 100 intended to engage with the analysis cartridge (FIG. 6).

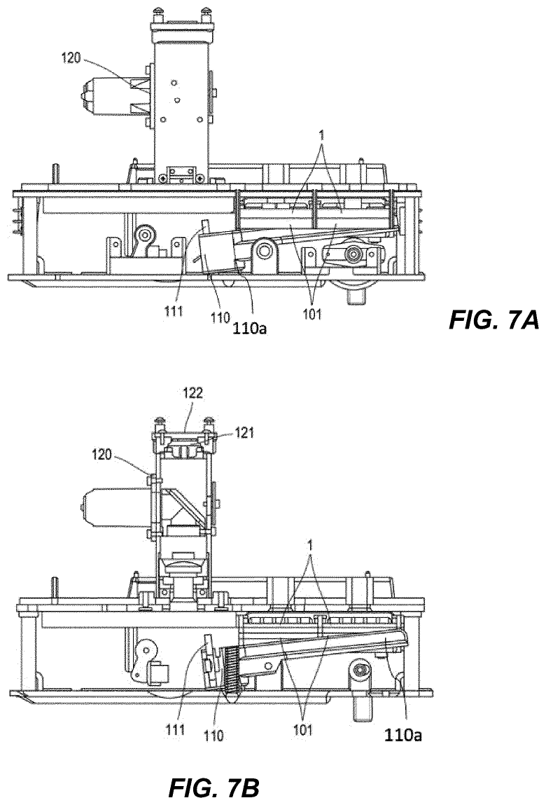

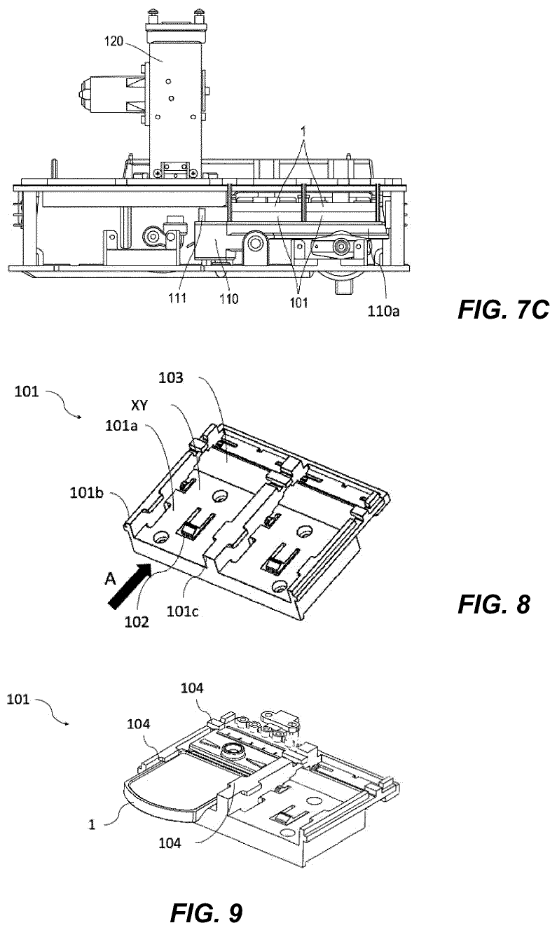

The analysis device 100 notably comprises a support 101 intended to receive at least one analysis cartridge 1 for the purpose of analyzing the liquid sample contained in the at least one analysis chamber 5 (FIGS. 7A-7C). More particularly, the support 101 is designed to receive the analysis cartridge 1 so that the analysis cartridge 1 rests on the support 101 by one of its faces. In the remainder of this disclosure, it will be assumed that the analysis cartridge rests on its rear face. However, this last aspect is not such as to limit the present disclosure and the skilled person will be able to consider an analysis cartridge resting on one of its faces opposite the rear face.

FIG. 8 shows, in these regards, a support 101 capable of being implemented within the scope of the present disclosure. In particular, the support 101 shown in this figure can accommodate two analysis cartridges.

The support 101 can also be configured to allow insertion of an analysis cartridge 1 according to a sliding movement along direction “A” (FIG. 8).

In particular, the support 101 comprises a bottom, a so-called support bottom 101a, and side walls 101b and 101c configured to guide the insertion of an analysis cartridge 1.

Snap-on means 102 can also be arranged on the support bottom 101a. The snap-on means 102 are notably configured to engage with the rear face of the analysis cartridge 1 in order to retain it on the support 101.

The support 101 is also perforated and comprises a window 103 formed on the support bottom 101a and intended to provide access to the rear face of the analysis cartridge 1 when this latter is inserted into the support 101. In particular, the window 103 can be positioned directly above the analysis chamber 5 of the analysis cartridge 1 arranged on the support 101.

Alternatively, the support can be configured to guide the vibrations imposed by the piezoelectric finger. In these regards, the support may comprise means for distributing the vibrations imposed on the cartridge by the piezoelectric finger. These distribution means may, in particular, be arranged to guide the vibrations at the at least one analysis chamber, and more particularly at each of the analysis chambers when there is a plurality of analysis chambers.

When placed on the support 101, the rear face of the analysis cartridge 1 is coincident (i.e., coplanar) with the XY plane. In particular, this XY plane is parallel to the support bottom 101a. The XY plane may, for example, be horizontal.

The side walls 101b and 101c also comprise cleats 104 that extend from a free edge of each of the side walls 101b and 101c (FIG. 9).

The cleats 104 (or wedges), together with the snap-on means 102, ensure that the analysis cartridge 1 is held in place on the support 101, and that the rear face of the cartridge 1 is coplanar with the XY plane. These holding means as described are configured to ensure coplanarity of the XY plane and the rear face of the analysis cartridge. However, the present disclosure is not limited to the means described and the skilled person will be able to implement any means ensuring the coplanarity of the XY plane and the rear face of the analysis cartridge.

Spring means can be arranged on the support bottom 101a. These spring means are notably configured to press the analysis cartridge 1 against the cleats 104, and thus ensure coplanarity of the XY plane and of the rear face of the analysis cartridge. The spring means may comprise levers. However, this last aspect is not such as to limit the scope of the present disclosure and the skilled person will be able to implement any other type of means presenting such a functionality.

The analysis device 100 may also comprise additional means for holding the analysis cartridge on the support. These additional holding means are notably configured to hold the analysis cartridge at the vents thereof and, in particular, so as to obturate the vents. This obturation of the vents notably prevents the liquid from being pumped out of the chamber and, as a result, the vibration amplitudes imposed by the piezoelectric finger can be increased. This latter aspect thus makes it possible to envisage shorter mixing times.

The analysis device 100 also comprises a stop rail. This stop rail is notably arranged to be opposite a face of the analysis cartridge opposite the rear face. In particular, the stop rail is arranged to limit the displacement of the analysis cartridge when the piezoelectric finger is in contact with the rear face. The support may also comprise one or more notches formed on its side walls 101b and 101c allowing contact (so-called stop contact) between the stop rail and the analysis cartridge.

The analysis device 100 also comprises piezoelectric vibration means 110 arranged to impose a vibration on the bottom of the analysis chamber so as to generate an acoustic pressure field in a liquid capable of being present in the at least one analysis chamber 5.

The piezoelectric vibration means 110 may comprise a transducer notably an elliptical transducer of the ELLIPTEC™ transducer type.

Alternatively, the piezoelectric vibration means 110 may comprise a piezostack. The piezoelectric vibration means 110 may comprise a so-called Langevin transducer (a Langevin transducer is made up of a stack of ceramics held between two metal parts that clamp the assembly together).

In these regards, it was demonstrated that these linear transducers have good mixing dynamics.

Bolt-clamped Langevin ultrasonic transducers are also highly effective.

Particularly advantageously, the piezoelectric vibration means 110 comprise a piezoelectric finger 111 that extends between a first end 111a and a second end 111b. It is understood, without needing to be specified, that a “finger,” insofar as it extends between a first and a second end, is a generally elongated element. Typically, the piezoelectric finger may be cylindrical in shape. However, the present disclosure is not limited to this aspect, and the skilled person will be able to consider other shapes. It is understood that the second end may be pointed, planar, rounded or comprise a plurality of contact points (rake-shaped).

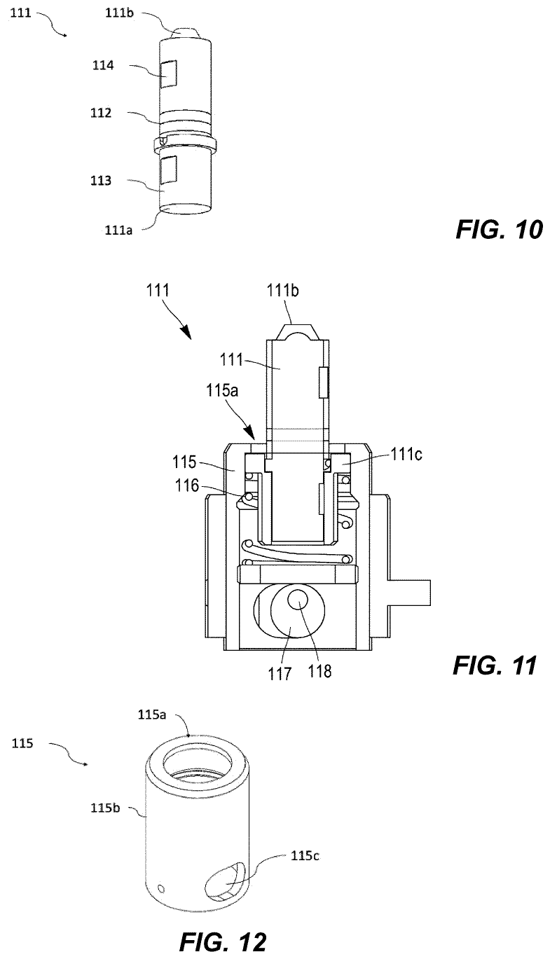

As shown in FIG. 10, the piezoelectric finger 111 may comprise a piezoelectric stack 112 sandwiched between a first element 113 and a second element 114, both of which are generally cylindrical in shape. The first element 113 notably extends from the first end 111a toward the piezoelectric stack 112 while the second element extends from the piezoelectric stack 112 toward the second end 111b. It is understood that the first element, the piezoelectric stack and the second element are mechanically integral with each other and in such a way as to ensure prestressing between these different elements. The prestress may be at least 10 times greater than the bearing force exerted by the second end when this latter is bearing against the rear face or the support. In particular, this prestress improves the coupling between the piezoelectric stack and the elements 113 and 114, and thus limits the influence of the bearing force on the vibration modes of the stack 112. In other words, the prestress may be greater than 20 MPa, advantageously greater than 35 MPa, even more advantageously greater than 50 MPa. The prestress improves the efficiency with which vibrations generated by the piezoelectric finger are transmitted to the analysis cartridge.

The piezoelectric vibration means 110 are arranged so that the piezoelectric finger 111 can adopt one or other of two positions known, respectively, as the engaged position and disengaged position.

In particular, the engaged position is a position in which the second end bears against the rear face when the analysis cartridge rests on the support, while the disengaged position is a position in which the contact end is at a distance from the rear face so as to allow the analysis cartridge 1 to be removed.

Moving from one of these two positions to the other may involve a pivot or translational movement.

Advantageously, the bearing force exerted by the piezoelectric finger on the rear face is perpendicular to the YZ plane when the finger is in its engaged position.

The analysis device 100 may also comprise engagement means configured to allow the piezoelectric finger to move between one of the engaged and disengaged positions to the other of these two positions.

By way of example, and as shown in FIGS. 7A-7C, the piezoelectric vibration means 110 may comprise a lever 110a on which the piezoelectric finger is mounted. In particular, the lever 110a is mounted so that it can rotate about an axis integral with the analysis device 100. In particular, in FIGS. 7A and 7B, the lever 110a forces the piezoelectric finger 111 into its disengaged position. In other words, the second end 111b of the piezoelectric finger 111 is at a distance from the rear face of the analysis cartridge resting on the support 101. In FIG. 7C, the piezoelectric finger 111 is in its engaged position and therefore has its second end 111b in contact with the rear face of the analysis cartridge 1. According to this aspect, the engagement means may comprise a motor.

FIG. 11 shows an example of piezoelectric vibration means in which the transition from one of the engaged and disengaged positions to the other of these two positions involves a translational movement.

In this example, the piezoelectric finger is notably moved along a direction parallel to its direction of elongation. More particularly, this translational movement may be perpendicular to the XY plane. It is therefore understood, without needing to be specified and according to this last aspect, that the piezoelectric finger can be mounted perpendicular to the XY plane.

According to the example shown in FIGS. 11 and 12, the piezoelectric vibration means comprise a hollow cylindrical body 115, which, together with the piezoelectric finger 111, forms a piston, a so-called piezoelectric piston. In particular, in this example, the piezoelectric finger 111 is partially housed, coaxially with the hollow cylindrical body, in the hollow cylindrical body 115. In other words, a section of the piezoelectric finger opens out through an opening 115a in the hollow cylindrical body 115. It is understood that the section of the piezoelectric finger opening through the opening comprises the second end 111b. The hollow cylindrical body 115 comprises a side wall 115b giving it its cylindrical shape.

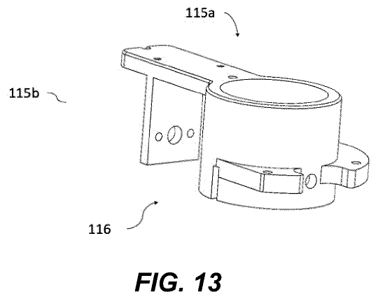

The piezoelectric vibration means further comprise a guide cylinder 116 (FIG. 11) and (FIG. 13), wherein the hollow cylindrical body is partially housed in a sliding connection (FIG. 11). In particular, the hollow cylindrical body 115 is mounted in the guide cylinder 116 so that the axis of elongation of the piezoelectric finger coincides with an axis of revolution of the guide cylinder 116.

Thus, the piezoelectric finger can adopt one or other of the engaged position or the disengaged position by translating the piezoelectric piston in the guide cylinder and parallel to the axis of revolution of the guide cylinder.

The transition from one to the other of the engaged position and the disengaged position is, according to the present disclosure, controlled by the engagement means. In particular, and as shown in FIG. 11, these engagement means comprise a cam 117 linked (by a fixed connection) to a shaft 118. In particular, the shaft 118 is mounted so that it can rotate about a fixed axis of the analysis device 100. More particularly, the shaft 118 passes through a wall of the guide cylinder 116 (the shaft is notably pivotally connected to the guide cylinder) and is configured to drive the cam 117 when it is rotated. In particular, the cam 117 may comprise a cylindrical block offset with respect to the shaft 118. However, the present disclosure is not limited to this type of cam, and the skilled person will be able to consider shapes other than a cylinder of revolution.

The cam 117 engages with at least one through-opening 115c arranged in the side wall of the hollow cylindrical body 115 in order to impose one or other of the engaged and disengaged positions on the piezoelectric finger, under the sole action of the cam 117. In particular, the at least one through-opening 115c arranged in the side wall of the hollow cylindrical body 115 and delimited by an inner surface on which the cam 117 is capable of exerting a force to impose one or other of the engaged and disengaged positions on the piezoelectric finger. In particular, the through-opening 115c has a shape suitable for allowing the transition from one or other of the engaged and disengaged positions to the other of these two positions. By way of example, the through-opening can have an elongated shape along a guide of the hollow cylindrical body.

Thus, during operation, the cam is capable of adopting two angular positions about an axis coinciding with the shaft, referred to, respectively, as the angular engagement position and angular disengagement position, the angular engagement position being a position in which the cam imposes the engagement position on the piezoelectric piston and the angular disengagement position being a position in which the cam imposes the disengagement position on the piezoelectric piston.

The arrangement of the engagement means as described above makes them more compact than systems known to the skilled person.

It is understood that the cam and the shaft extend along an axis perpendicular to the axis of elongation of the piezoelectric finger.

It is also understood that the shaft can be rotated by means of a motor.

According to a particularly advantageous embodiment, the piezoelectric vibration means comprise a suspension mechanism configured so that the piezoelectric finger, as soon as it is in its engaged position, imposes a predetermined contact force on the rear face. In other words, the suspension mechanism is configured to allow the piezoelectric finger in the hollow cylindrical body to retract as soon as it comes into contact with the rear face and so as to limit the force exerted by the finger on the rear face to the predetermined contact force.

According to a particularly advantageous embodiment, the suspension mechanism comprises a spring 119 mounted in compression and bearing, on the one hand, against the hollow cylindrical body and, on the other hand, against a shoulder 111c of the piezoelectric foot. The shoulder may notably be formed by an edge of a sleeve wherein the piezoelectric finger is attached. It is assumed in this description that the shoulder is a component of the piezoelectric finger.

In particular, when no stress is imposed, the suspension mechanism holds the piezoelectric finger 111 in abutment, for example, by its shoulder, along a direction, known as the direct direction, from the first end to the second end, against a stop on the hollow cylindrical body. As soon as it comes into contact with the rear face of the analysis cartridge, the piezoelectric finger partially retracts, exerting a compressive force on the spring 119 along a direction opposite to the forward direction. By selecting an appropriate spring constant of the spring 119, a predetermined contact force (or bearing force) can be imposed on the rear face of the analysis cartridge. In an alternative and/or complementary manner, the piezoelectric piston may comprise means for adjusting the compression of the spring. These adjustment means may notably comprise a screwing system or a screwing washer engaging with the hollow cylindrical body. However, the present disclosure is not limited to these screwing systems, and the skilled person will be able to consider any other technical solution for adjusting spring compression.

Advantageously, the bearing force may be between 1 N and 50 N, advantageously between 1 N and 25 N, even more advantageously between 1 N and 20 N. In addition, the bearing force can be exerted on a surface area of between 4 mm² and 64 mm².

Thus, for a bearing force of 1 N on a surface area of 4 mm² or 64 mm², the pressure exerted is of the order of 5000 Pa and 156.25 Pa, respectively.

Equivalently, for a bearing force of 50 N on a surface area of 4 mm² or 64 mm², the pressure exerted is of the order of 125 kPa and 7812.5 Pa, respectively.

The movement of the chamber bottom under the effect of the bearing force to start mixing, and optionally generate bubbles, may be between 0.2 and 4 μm, more advantageously between 2 and 4 μm.

The analysis device 100 may also be configured to move the analysis cartridge 1 and/or the piezoelectric vibration means 110, so as to be able to successively match each of the analysis chambers to the piezoelectric vibration means and thus successively and specifically impose a vibration on the bottom of each of the analysis chambers. Thus, the analysis cartridge can be moved sideways to face the piezoelectric vibration means. In a complementary manner, the piezoelectric vibration means can be arranged to be moved along a horizontal direction so as to bring the finger of the means into contact with the rear face of the analysis cartridge.

Thus, by way of example, the analysis device comprises a worm gear engaging with the support and configured to impose one or other of an analysis position and a loading position on the support. The loading position is a position for placing and/or removing the analysis cartridge from the support, while the analysis position is a position for engaging the piezoelectric finger against the rear face of the analysis cartridge. Alternatively, implementation of a rack and pinion may be considered.

The analysis device 100 may comprise complementary magnetic means for imposing a complementary magnetic field in at least one analysis chamber of the analysis cartridge. The complementary means are advantageously implemented when a non-magnetic layer 6c is considered.

The analysis device 100 may further comprise means for analyzing the sample present in the at least one analysis cartridge 1. These analysis means 120 engage with the detection agent 10a. The analysis means 120 may, in these regards, comprise optical means, and more particularly an epifluorescence microscope.

More particularly, the analysis means 120 are configured to locate/detect the complexes 12 immobilized on the bottom of the analysis chamber 5 by the magnetic layer 6b. In particular, these immobilized complexes form a pattern dictated by the arrangement of the magnetic regions of the magnetic layer 6b.

Also, as long as the detection agents associated with the immobilized complexes 12 carry a marker, it is possible to reveal the immobilized complexes 12.

In particular, the marker carried by the detection agents may be photoluminescent, for example, fluorescent.

Thus, the analysis means of the analysis device may advantageously comprise a radiation source 121 and a detector 122. The radiation source is notably intended to induce the emission of a photoluminescence signal by the markers, while the detector is configured to collect the photoluminescence signal.

The piezoelectric vibration means, as described in the present disclosure, can be used to mix, and/or concentrate, a liquid and/or elements included in this liquid for analysis purposes. These piezoelectric vibration means may also be implemented to move the liquid, for example, from one chamber to the other (these two chambers being linked by a fluidic channel), to pump a liquid, for example, to a chamber of the analysis cartridge.

1. An analysis device for biological analysis to detect the presence and/or concentration of a species in a liquid, comprising:
a support for receiving at least one analysis cartridge so that the analysis cartridge rests on the support by a face of the support, the analysis cartridge having an essentially planar rear face coincident with an XY plane, the analysis cartridge comprising at least one chamber capable of containing a liquid intended to be analyzed;
piezoelectric vibration means equipped with a piezoelectric finger that extends between a first end and a second end of the finger, a hollow cylindrical body that, together with the piezoelectric finger, forms a piezoelectric piston, the piezoelectric finger being partially housed, coaxial with the hollow cylindrical body, in the hollow cylindrical body and partly opens out through an opening in the hollow cylindrical body, the piezoelectric vibration means further comprising a guide cylinder in which the hollow cylindrical body is partially housed in sliding connection, the piezoelectric vibration means being arranged so that the piezoelectric piston can adopt one or another of an engaged position and a disengaged position, the engaged position being a position wherein the second end bears against the support or against the rear face when the analysis cartridge rests on the support, while the disengaged position is a position in which the second end is at a distance from the rear face so as to allow the analysis cartridge and the support to be removed; and
engagement means configured to allow the piezoelectric finger to move between one of the engaged position and the disengaged position to the other of these two positions, the engagement means comprising a cam carried by one end of a shaft, the shaft being pivotally connected to the guide cylinder and passing through the hollow cylindrical body perpendicular to the piezoelectric finger, the cam engaging with a through-opening arranged in the side wall of the hollow cylindrical body so that the piezoelectric piston adopts one or the other of the engaged position and the disengaged position by the sole action of the cam, the shaft (118) is advantageously rotationally controlled by means of a motor, in particular a stepper motor.

2. The analysis device of claim 1, wherein the cam is capable of adopting two angular positions including an angular engagement position and an angular disengagement position, the angular engagement position being a position for which the cam imposes the engagement position on the piezoelectric piston and the angular disengagement position being a position for which the cam imposes the disengagement position on the piezoelectric piston.

3. The analysis device of claim 2, wherein the through-opening is delimited by an inner surface on which the cam 118 is capable of exerting a force to impose one or another of the engaged position or the disengaged position on the piezoelectric piston.

4. The analysis device of claim 1, wherein the piezoelectric finger is configured to impose a vibration on the rear face as the second end bears against the rear face.

5. The analysis device of claim 1, wherein the piezoelectric finger is configured to exert, against the rear face, a bearing force perpendicular to the XY plane when the piezoelectric finger is in the engaged position.

6. The analysis device of claim 1, further comprising complementary magnetic means intended to impose a complementary magnetic field in the at least one chamber of the analysis cartridge.

7. The analysis device of claim 1, further comprising analysis means for analyzing the liquid capable of being present in the at least one chamber.

8. The analysis device of claim 7, wherein the analysis means comprise a detector and a radiation source configured to analyze a liquid capable of being present in the analysis chamber.

9. The analysis device of claim 1, wherein the support is perforated so as to make the rear face of the analysis cartridge accessible via the second end when the cartridge rests with its rear face on the support.

10. The analysis device of claim 1, further comprising loading means engaging with the support and configured to impose on the support one or another of an analysis position and a loading position, the loading position being a position allowing the positioning and/or removal of the analysis cartridge from the support, the analysis position being a position allowing the engagement of the piezoelectric finger against the rear face of the analysis cartridge.

11. The analysis device of claim 10, further comprising analysis means for analyzing the liquid capable of being present in the at least one chamber, and wherein the analysis position is also a position allowing analysis of the fluid contained in the chamber by the analysis means.

12. The analysis device of claim 1, wherein the piezoelectric vibration means comprise a suspension mechanism configured so that the piezoelectric finger, as soon as it is in its engaged position, imposes a predetermined contact force on the rear face.

13. The analysis device of claim 1, wherein the support comprises wedges configured to force the rear face of the analysis cartridge to be coincident with the XY plane.

14. The analysis device of claim 13, further comprising additional means for holding the analysis cartridge on the support, the additional holding means configured to hold the analysis cartridge at vents of the cartridge and communicating with the chamber, the additional holding means further configured to obturate the vents.

15. The analysis device of claim 1, wherein the shaft is rotationally controlled by way of a motor.

16. The analysis device of claim 15, wherein the motor comprises a stepper motor.

17. The analysis device of claim 3, wherein the through-opening has an elongated shape along a guide of the hollow cylindrical body.

18. The analysis device of claim 10, wherein the loading means comprises a worm gear.

19. The analysis device of claim 12, wherein the suspension mechanism comprises a spring mounted in compression and bearing on against the hollow cylindrical body and against a shoulder of the piezoelectric finger.

20. The analysis device of claim 3, wherein the piezoelectric finger is configured to impose a vibration on the rear face as the second end bears against the rear face.
